(19) United States
(12) Patent Application Publication
(10) Pub. No.: US 2008/0088182 A1
(43) Pub. Date: Apr. 17, 2008

(54) Transfer switch with multiple power source disconnect

(75) Inventor: Todd Matthew Lathrop, Oakdale, PA (US)

Correspondence Address: Martin J. Moran;Eaton Electrical, Inc., Technology & Quality Center, 170 Industry Drive, RIDC Park West, Pittsburg, PA, 15275-1032, US

(73) Assignee: Eaton Corporation

(21) Appl. No.: 11/546,058

(22) Filed: Oct. 11, 2006

(51) Int. Cl. H02J 9/06

(52) U.S. Cl. 307/64

(57) ABSTRACT

A transfer switch provides electric power to a load. The transfer switch includes a power switching device provided with electric power from a first power source and a second power source. During a disconnect mode, the transfer switch disconnects both the first and second power sources by causing a service disconnect interposed between the first power source and the power switching device to enter an open state and by causing the power switching device to select the first power source.

### BACKGROUND OF THE INVENTION

1. Field of the Invention

This invention pertains generally to transfer switches, and more particularly, to transfer switches for disconnecting multiple alternate power sources from a load. This invention also relates to methods for disconnecting multiple alternate power sources.

2. Background Information

Transfer switches are employed in a wide variety of residential and commercial structures to allow an electrical load therein to be supplied with power from an alternate power source in the event of instability and/or loss of power from a main power source. A typical transfer switch installation allows an onsite backup electrical generator, serving as a generator power source, to supply electrical power in place of a utility power source on an occasion where the electrical power supplied by the utility power source has become unstable (e.g., as in the case of a brownout) or has failed, entirely.

In the interests of safety, various organizations have promulgated standards for minimum characteristics for transfer switches and transfer switch installations. Underwriters Laboratories, Inc. (UL) has promulgated the UL1008 standard requiring the ability to disconnect all electrical service at the location of a transfer switch installed at the point of entry of electrical service into a structure. This is to ensure that individuals such as fire personnel are able to disconnect all electrical power from the structure when necessary at a single location, as when a fire potentially involving electrical power must be extinguished.

UL has also promulgated the UL2200 standard requiring electric generators to incorporate a service disconnect device (e.g., a circuit breaker, or other electrical device providing both overcurrent protection and manual disconnect capability) within the generator, itself. This is to allow the power supplied by an electric generator to be disconnected at the source at such times as when maintenance is being performed on the generator or on power lines conveying the generator's electrical output.

Another organization, the National Fire Protection Association, promulgates the National Electric Code (NEC), which is a set of standards adopted in many states and countries as the basis of minimum requirements for various aspects of electrical wiring in residential and commercial structures. The NEC requires only that a service disconnect device be installed between an electric generator and a transfer switch to which it supplies power as a generator power source, and does not specify the location of that service disconnect device.

Due to the undesirable levels of noise, vibration, and exhaust fumes of most electric generators, as well as their typically unsightly appearance, it is commonplace for generators to be located outside residential and commercial structures in places where they are not so easily seen or heard. Therefore, the service disconnect device incorporated into the generator to comply with UL2200, is often not located in sufficiently close proximity to a transfer switch as to also comply with UL1008. As a result, a common practice has evolved that entails incorporating an additional service disconnect device for the generator power source into the transfer switch alongside a disconnect device for the utility power source. Given that UL1008 requires only that the electrical power supplied by a generator power source be able to be disconnected at the transfer switch, and that the NEC requires only that a service disconnect device be located somewhere between the generator power source and the transfer switch, the incorporation of an additional source disconnect device into the transfer switch is redundant. It would be desirable to meet the requirements of UL1008, UL2200 and the NEC without such a redundant component.

### SUMMARY OF THE INVENTION

These needs and others are met by embodiments providing a transfer switch having a power switching device and a service disconnect with the ability to disconnect multiple alternate sources of power from a load through the use of a single disconnect control operable, for example, by maintenance or emergency personnel. For example, movement of the disconnect control to a disconnect position causes the service disconnect to enter an open state, thereby disconnecting a first power source that is otherwise provided to the power switching device. Movement of the disconnect control to a disconnect position also causes the power switching device to select the first power source, thereby disconnecting a second power source provided to the power switching device without the use of an additional service disconnect. The service disconnect remains in an open state and the power switching device continues to select the first power source until at least the disconnect control has been moved to an energize position, thereby allowing the transfer switch to function normally. In some embodiments, in addition to movement of the disconnect control to the energize position, the service disconnect may also need to be manually reset.

In some embodiments, the transfer switch additionally incorporates an automatic transfer control to automatically select between first and second power sources to ensure a steady supply of electricity to the load. The disconnect control may provide an input to the automatic transfer control to signal the automatic transfer control to cause the service disconnect to enter an open state and to cause the power switching device to select the first power source in response to the disconnect control being moved to the disconnect position.

In accordance with one aspect of the invention, a transfer switch comprises a power switching device structured to select between a first power source and a second power source and supply power to a load; a service disconnect interposed between the first power source and the power switching device and structured to disconnect the first power source from the power switching device; and a disconnect control structured to cause the power switching device to select the first power source and to cause the service disconnect to disconnect the first power source from the power switching device in response to the disconnect control being set to a disconnect mode.

In accordance with another aspect of the invention, an automatic transfer switch comprises a power switching device structured to select between a first power source and a second power source and supply power to a load; a service disconnect interposed between the first power source and the power switching device and structured to disconnect the first power source from the power switching device; an automatic transfer control structured to monitor the first power source and to cause the power switching device to select the second power source in response to failure or instability of the first power source; and a disconnect control structured to cause the power switching device to select the first power source and to cause the service disconnect to disconnect the first power source from the power switching device in response to the disconnect control being set to a disconnect mode.

In accordance with another aspect of the invention, a method of disconnecting power provided to a load through a power switching device of a transfer switch from a first power source capable of providing power to the power switching device and a second power source capable of providing power to the power switching device comprises disconnecting the second power source by causing the power switching device to select the first power source in response to a disconnect mode; and disconnecting the first power source by causing a service disconnect interposed between the first power source and the power switching device to enter an open state in response to the disconnect mode.

In accordance with still another aspect of the invention, a method of disconnecting power provided to a load through a power switching device of a transfer switch from a first power source capable of providing power to the power switching device and a second power source capable of providing power to the power switching device comprises disconnecting the second power source by causing the power switching device to select the first power source in response to a disconnect mode; disconnecting the first power source by causing a service disconnect interposed between the first power source and the power switching device to enter an open state in response to the disconnect mode; and allowing, in response to an energize mode, an automatic transfer control to cause selection of the second power source by the switching device in response to failure or instability of the first power source.

### BRIEF DESCRIPTION OF THE DRAWINGS

A full understanding of the invention can be gained from the following description of the preferred embodiments when read in conjunction with the accompanying drawings in which:

FIGS. 1 and 2 are a block diagrams of transfer switch installations in accordance with embodiments of the invention; and

FIGS. 3 and 4 are flowcharts of disconnection of multiple alternate power sources in accordance with embodiments of the invention.

### DESCRIPTION OF THE PREFERRED EMBODIMENTS

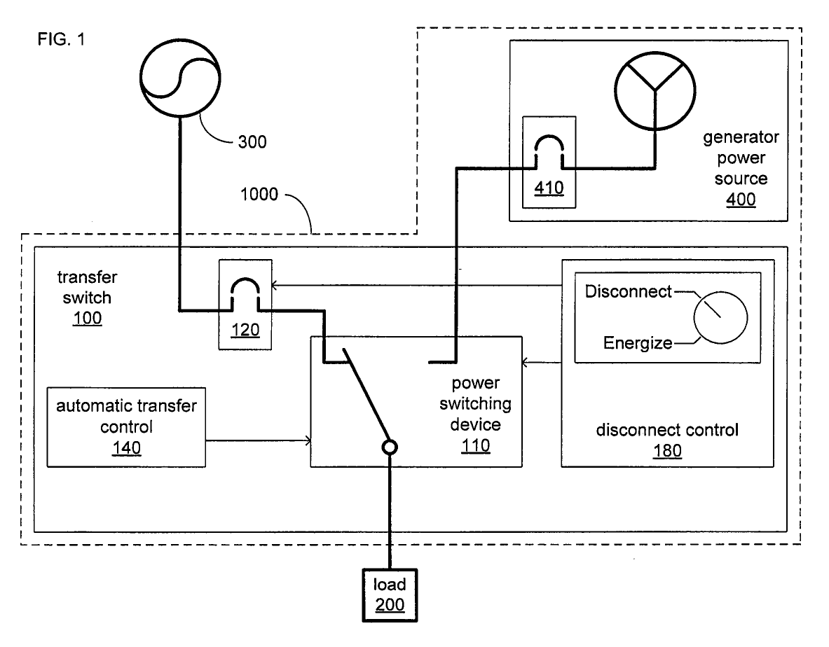

Referring to FIG. 1, a transfer switch installation 1000 to selectively provide electrical power to a load 200 from multiple alternate sources incorporates a generator power source 400 and a transfer switch 100 receiving electric power, at various times, from one or both of a utility power source 300 and the generator power source 400. The transfer switch 100 allows the source of electric power supplied to the load 200 to be switched between the utility power source 300 and the generator power source 400. The load 200 represents one or more electrical devices within, for example, a commercial or residential structure (not shown) that requires electric power, such as for example and without limitation, lighting, plug-ins, appliances, commercial machinery and climate control systems. The utility power source 300 is a source of electric power from a commercial vendor (e.g., without limitation, a connection to an electrical grid maintained by a utility power company).

The generator power source 400 is, for example, an electric generator of a type commonly found near the exterior of a commercial or residential structure to provide a backup source of electric power to that structure in the event that the electric power supplied by the utility power source 300 becomes unstable (as in the case of a brownout) or fails, entirely. The generator power source 400 incorporates a generator service disconnect 410 to disconnect power during maintenance and/or in the event of an overload of current being drawn from the generator power source 400. The generator power source 400 may be any of a wide variety of electric generators based on any of a variety of technologies, including but not limited to, solar energy, wind energy, geothermal energy, or fossil fuel energy through either a fuel cell or an internal combustion engine.

The transfer switch 100 incorporates a power switching device 110, a service disconnect 120, and a disconnect control 180. As will be explained, the transfer switch 100 may also incorporate an automatic transfer control 140. As will also be explained, the disconnect control 180 provides the ability to manually disconnect from the load 200 all electric power supplied by either the utility power source 300 or the generator power source 400. Electric power from the utility power source 300 is routed via one or more conductors through the service disconnect 120 and to the power switching device 110. Electric power from the generator power source 400 is routed via one or more conductors from the generator service disconnect 410 within the generator power source 400 and to the power switching device 110. The power switching device 110 is caused to select either the utility power source 300 or the generator power source 400 to supply electric power that is routed via one or more conductors from the power switching device 110 to the load 200.

As those skilled in the art will readily recognize, the power switching device 110 may be any of a wide variety of devices or combinations of devices that provide the function of both making and breaking electrical connections for the routing of electric power to one or more. For example, it is widely known to use one or more sets of relays and/or contactors as a power switching device.

As those skilled in the art will also readily recognize, the service disconnect 120 and the generator service disconnect 410 may be any of a wide variety of devices or combinations of devices providing both protection against too great a flow of current and manual disconnection capability. A widely known and very common form of device employed as a service disconnect is a circuit breaker. Circuit breakers commonly provide a manual operating handle by which disconnection can be effected, and/or a shunt trip (e.g., a magnetic coil that when energized causes the circuit breaker to enter an open state). Widely known and commonly used combinations of devices serving as a service disconnect are a fuse and either a latching relay or latching contactor where disconnection is caused by breaking the circuit conveying power for latching.

During normal operation of the transfer switch 100, the power switching device 110 is normally caused to select the utility power source 300 as the source of electric power to be supplied to the load 200, but can be caused to select the generator power source 400 when the electric power supplied by the utility power source 300 becomes unstable or fails. In some embodiments, the power switching device 110 is caused to select a source of electric power through manual operation by an individual in response to that individual's observations of the condition of the utility power source 300 and/or the generator power source 400. In such embodiments, such an individual operates a manual control (not shown) located either at the site of the transfer switch 100 or at a more remote location. The connection between such a manual control and the power switching device 110 may employ a mechanical linkage, a transfer of an electrical signal, or some other suitable mechanism.

In other embodiments, the transfer switch 100 incorporates the automatic transfer control 140, and the power switching device 110 is caused to select a source of electric power under the control of the automatic transfer control 140. The automatic transfer control 140 is an electronic circuit that causes the power switching device 110 to select between the utility power source 300 and the generator power source 400 in response to the receipt of one or more inputs. Such inputs may include, for example and without limitation, an indication of the input voltage level supplied by one or both of the utility power source 300 and the generator power source 400, an indication of the amount of current being drawn from either of these power sources, a timer input, or a signal from a manually-operated switch.

Normal operation, as just described, is enabled by the disconnect control 180 being moved to an “Energize” position in which the load 200 is allowed to be powered from whichever one of the utility power source 300 or the generator power source 400 is selected by the power switching device 110. However, when the disconnect control 180 is moved to a “Disconnect” position, the transfer switch 100 enters a disconnect mode in which normal provision of electric power from any power source to the load 200 through the transfer switch 100 is prevented. Such a disconnect mode may be useful in various situations, including and without limitation, maintenance and emergencies, during which all sources of electric power to the load 200 must be disconnected to ensure safety.

Specifically, with the movement of the disconnect control 180 to the “Disconnect” position, the service disconnect 120 is caused to disconnect the utility power source 300 by entering an open state. Also, the power switching device 110 is caused to disconnect the generator power source 400 by selecting the utility power source 300. With the service disconnect 120 open such that electric power from the utility power source 300 does not reach the power switching device 110, and with the power switching device 110 selecting the utility power source 300 such that the generator power source 400 is not selected, the load 200 is not supplied with electric power by either the utility power source 300 or the generator power source 400. As long as the disconnect control 180 remains in the “Disconnect” position, the service disconnect 120 is prevented from entering a closed state and the power switching device 110 is prevented from selecting any other source of electric power than the now disconnected utility power source 300. In this way, both of these power sources are disconnected, and without the use of any service disconnect interposed between the power switching device 110 and the generator power source 400, including the generator service disconnect 410.

As those skilled in the art will readily recognize, various mechanical and/or electrical mechanisms may be employed in causing the service disconnect 120 to enter an open state, and causing the power switching device 110 to select the utility power source 300, in response to the disconnect control 180 being moved to the “Disconnect” position. In embodiments where the service disconnect 120 is a circuit breaker, the disconnect control 180 may transmit a signal to the circuit breaker energizing a shunt trip coil within the circuit breaker to cause disconnection. In other embodiments where the service disconnect 120 is a combination of a fuse and either a latching contactor or latching relay, the latching power may be removed by the disconnect control 180 to cause disconnection. In embodiments where the power switching device 110 employs one or more sets of contactors, the disconnect control 180 may energize one or more coils among the sets of contactors to cause the selection of the utility power source 300. In still other embodiments, one or both of the service disconnect 120 and the power switching device 110 may be mechanically linked to the disconnect control 180 so as to be mechanically manipulated by movement of the disconnect control 180 between the “Energize” and “Disconnect” positions.

Additionally, in some embodiments, when the disconnect control 180 is moved from the “disconnect” position to the “energize” position, an operating handle (not shown) of the service disconnect 120 may also need to be moved to cause the service disconnect to enter a closed state to reconnect the utility power source 300 to the power switching device 110. In such embodiments where the service disconnect 120 is a circuit breaker, it may be the operating handle of the circuit breaker that performs this function.

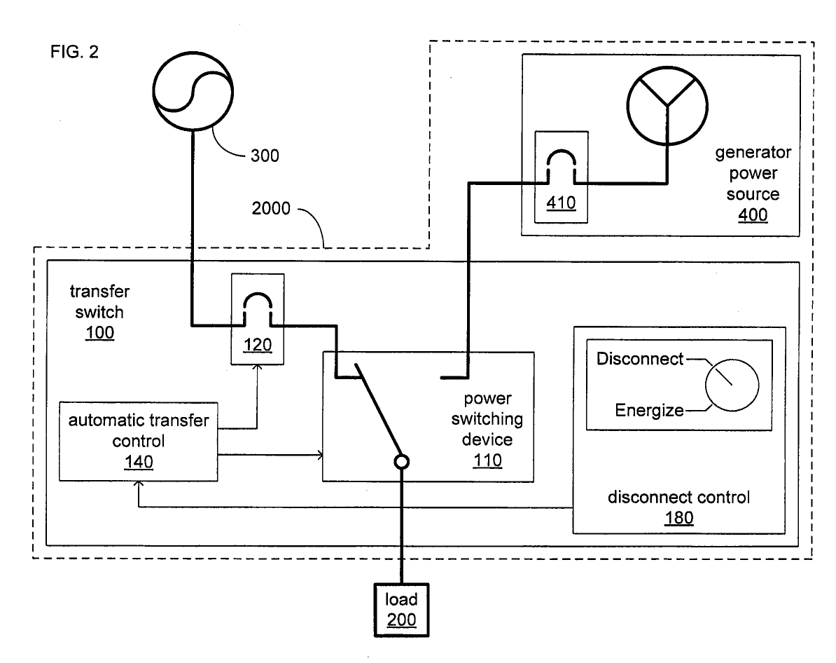

FIG. 2 depicts another transfer switch installation 2000 to selectively provide electrical power to a load 200. The transfer switch installation 2000 is substantially similar to the transfer switch installation 1000 of FIG. 1 with the majority of numbered items being identical, or at least substantially similar, such that identical numbering has been used between these figures. Like the transfer switch installation 1000 of FIG. 1, the transfer switch installation 2000 of FIG. 2 incorporates a generator power source 400, and a transfer switch 100 receiving electric power, at various times, from one or both of the utility power source 300 and the generator power source 400. The most substantial difference between the transfer switch installations 1000 and 2000 is the manner in which the power switching device 110, the service disconnect 120, the automatic transfer control 140 and the disconnect control 180 interact within the transfer switch 100.

In the transfer switch installation 1000 of FIG. 1, the disconnecting of electric power to the load 200 from both the utility power source 300 and the generator power source 400 was caused to occur independently of any activity involving the automatic transfer control 140, and some embodiments described with respect to FIG. 1 do not incorporate the automatic transfer control 140. In contrast, in the transfer switch installation 2000, the automatic transfer control 140 is involved in the disconnecting of both the utility power source 300 and the generator power source 400 in the transfer switch 100. In the transfer switch 100 of the transfer switch installation 2000, the disconnect control 180 provides an input to the automatic transfer control 140, and the automatic transfer control 140 is able to control the service disconnect 120 and the power switching device 110 in response to this input. Movement of the disconnect control 180 between the “Energize” and “Disconnect” positions causes the disconnect control 180 to signal the automatic transfer control 140 to either enter a normal mode of operation, or a disconnect mode.

During normal operation of the transfer switch 100, the power switching device 110 is normally caused by automatic transfer control 140 to select the utility power source 300 as the source of electric power to be supplied to the load 200. The automatic transfer control 140 monitors the electric power (e.g., without limitation, voltage) provided by the utility power source 300 for an indication of a need to select the generator power source 400. Just like the automatic transfer control 140 of the transfer switch installation 1000 of FIG. 1, the automatic transfer control 140 of the transfer switch installation 2000 of FIG. 2 is an electronic circuit that causes the power switching device 110 to select between the utility power source 300 and the generator power source 400 in response to the receipt of one or more inputs. Such inputs may include, and without limitation, an indication of the voltage level of the electric power supplied by one or both of the utility power source 300 and the generator power source 400, an indication of the amount of current being drawn from either power source, a timer input, or a signal from a manually-operated switch.

However, with the movement of the disconnect control 180 to the “Disconnect” position, the automatic transfer control 140 is signaled to enter into the disconnect mode. In this mode, the automatic transfer control 140 causes the service disconnect 120 to disconnect the utility power source 300 by entering an open state, and causes the power switching device 110 to disconnect the generator power source 400 by selecting the utility power source 300. Just as in the case of the transfer switch installation 1000 of FIG. 1, causing the service disconnect 120 to enter an open state and causing the power switching device 110 to select the utility power source 300 in the transfer switch installation 2000 also results in the load 200 being disconnected from both the utility power source 300 and the generator power source 400. From the moment the automatic transfer control 140 receives an input indicating that the disconnect control 180 has been moved to the “Disconnect” position to the moment the automatic transfer control 140 receives an input indicating that the disconnect control 180 has been moved to the “Energize” position, the automatic transfer control 140 remains in the disconnect mode. While in this mode, the automatic transfer control 140 will neither cause the service disconnect 120 to enter a closed state nor cause the power switching device 110 to select the generator power source 400, regardless of what other input is received.

Additionally, as in the case of some embodiments of the transfer switch 100 of the transfer switch installation 1000, some embodiments of the transfer switch 100 of the transfer switch installation 2000 may require an operating handle (not shown) of the service disconnect 120 to be moved to cause the service disconnect to enter a closed state, in addition to moving the disconnect control 180 to the “energize” position, to re-enable normal operation of the transfer switch 100.

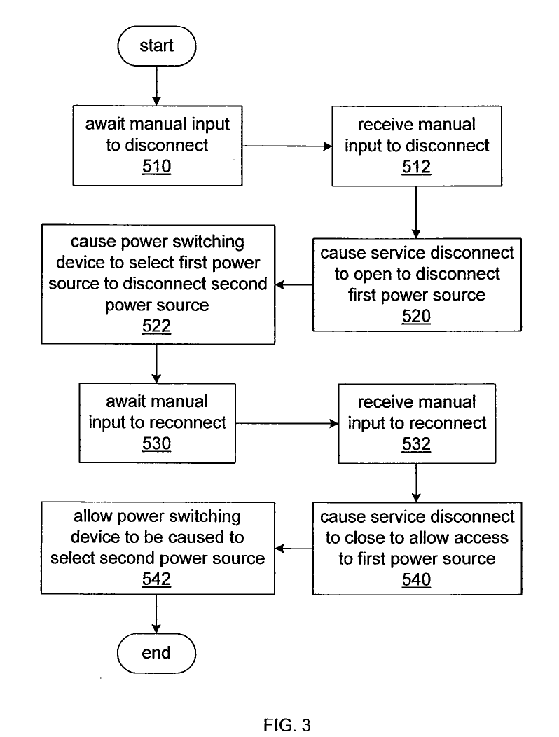

FIG. 3 is a flowchart of an example disconnection procedure. Manual input to disconnect all electric power from a load within a structure is awaited at 510, and at 512, that input is received. At 520, in response to the receipt of the input to disconnect, a service disconnect (e.g., without limitation, a circuit breaker) is caused to enter an open state to disconnect a first power source. At 522, also in response to the receipt of the input to disconnect, a power switching device is caused to select the first power source to disconnect a second power source. It should be noted that steps 520 and 522 may occur in the reverse order from what is presented in FIG. 3. Manual input to reconnect power to the load is then awaited at 530, and at 532, that input is received. At 540, in response to the receipt of the input to reconnect, the service disconnect is caused to enter a closed state. Alternatively, in some embodiments, the service disconnect 120 may need to be separately manually operated to cause it to enter a closed state at 540. At 542, also in response to the receipt of the input to reconnect, the power switching device is allowed to resume selecting either the first power source or the second power source, depending on the condition of the first power source and/or other suitable factors.

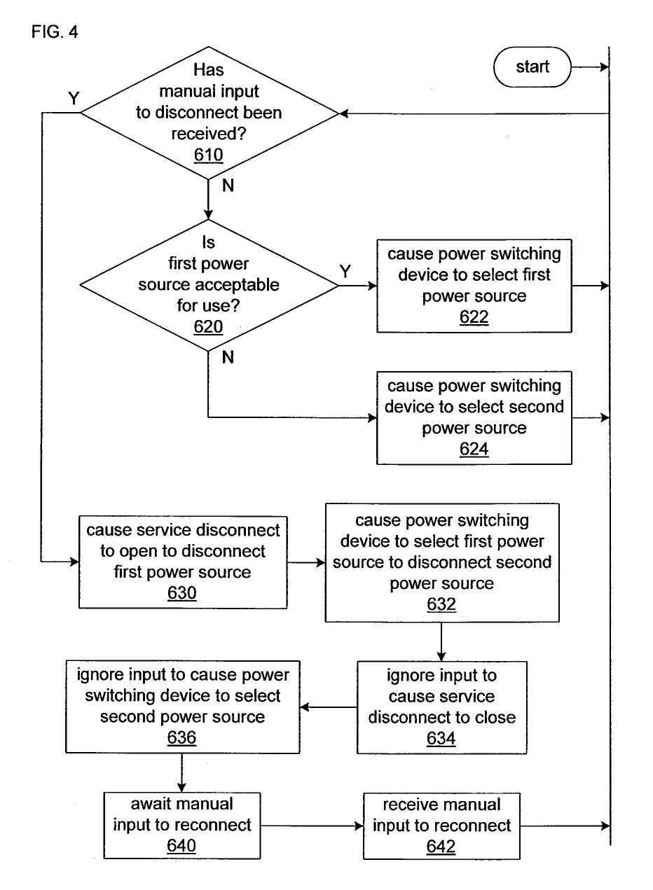

FIG. 4 is another flowchart of an example disconnection procedure. At 610, if no manual input to disconnect all electric power from a load within a structure is received, then at 620 a determination is made as to whether the first power source is acceptable for use, or not. As those skilled in the art will readily recognize, the criterion for determining the acceptability of the first power source may greatly vary, and may include, without limitation, such considerations as the voltage level of the first power source, or how much time has passed since some form of instability was recently detected in the electric power provided by the first power source. If the first power source is determined to be acceptable, then at 622, the power switching device is caused to select the first power source, if the power switching device has not already been caused to select the first power source. If the first power source is determined to not be acceptable, then at 624, the power switching device is caused to select the second power source, if the power switching device has not already been caused to select the second power source. Regardless of which power source the power switching device has been caused to select, at 610, the question of whether a manual input to disconnect has been received, or not, is again evaluated.

If at 610, a manual input to disconnect all electric power from the load has been received, then at 630, a service disconnect is caused to enter an open state to disconnect the first power source from the power switching device, and at 632, the power switching device is caused to select the first power source to disconnect the second power source, thereby disconnecting both power sources from the load. It should be noted that steps 630 and 632 may occur in the reverse order from what is presented in FIG. 4. At 634, an input to cause the service disconnect to enter a closed state is ignored, and at 636, an input to cause the power switching device to select the second power source is ignored. Like steps 630 and 632, it should be noted that steps 634 and 636 may occur in the reverse order from what is presented in FIG. 4. A manual input to reconnect electric power to the load is awaited at 640, and at 642, that input is received, thereby allowing the question of whether a manual input to disconnect has been received, or not, to again be evaluated at 610.

It should be noted that although the disconnect control 180 has been described as being movable between a “disconnect” position and an “energize” position, other nomenclature may be used to describe these two settings.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A transfer switch comprising:
a power switching device structured to select between a first power source and a second power source and supply power to a load;
a service disconnect interposed between the first power source and the power switching device and structured to disconnect the first power source from the power switching device; and
a disconnect control structured to cause the power switching device to select the first power source and to cause the service disconnect to disconnect the first power source from the power switching device in response to the disconnect control being set to a disconnect mode.

2. The transfer switch of claim 1, wherein the power switching device comprises a contactor.

3. The transfer switch of claim 1, wherein the service disconnect is a circuit breaker.

4. The transfer switch of claim 3, wherein the circuit breaker comprises a shunt trip that is energized to cause the circuit breaker to disconnect the first power source from the power switching device in response to the disconnect control being set to the disconnect mode.

5. The transfer switch of claim 1, wherein the disconnect control is structured to allow the power switching device to select the second power source and to cause the service disconnect to reconnect the first power source to the power switching device in response to the disconnect control being set to an energize mode.

6. The transfer switch of claim 5, wherein the disconnect control comprises a manually operable switch to select between the disconnect mode and the energize mode.

7. An automatic transfer switch comprising:
a power switching device structured to select between a first power source and a second power source and supply power to a load;
a service disconnect interposed between the first power source and the power switching device and structured to disconnect the first power source from the power switching device;
an automatic transfer control structured to monitor the first power source and to cause the power switching device to select the second power source in response to failure or instability of the first power source; and
a disconnect control structured to cause the power switching device to select the first power source and to cause the service disconnect to disconnect the first power source from the power switching device in response to the disconnect control being set to a disconnect mode.

8. The automatic transfer switch of claim 7, wherein the automatic transfer control is prevented from causing the power switching device to select the second power source when the disconnect control is set to the disconnect mode.

9. The automatic transfer switch of claim 7, wherein the automatic transfer control is structured to cause the power switching device to select the first power source and to cause the service disconnect to disconnect the first power source from the power switching device, in response to the disconnect control being set to the disconnect mode.

10. A method of disconnecting power provided to a load through a power switching device of a transfer switch from a first power source capable of providing power to the power switching device and a second power source capable of providing power to the power switching device, said method comprising:
disconnecting the second power source by causing the power switching device to select the first power source in response to a disconnect mode; and
disconnecting the first power source by causing a service disconnect interposed between the first power source and the power switching device to enter an open state in response to the disconnect mode.

11. The method of claim 10, said method further comprising preventing the power switching device from selecting the second power source during the disconnect mode.

12. The method of claim 10, said method further comprising preventing the service disconnect from entering a closed state during the disconnect mode.

13. The method of claim 10, said method further comprising employing a circuit breaker comprising a shunt trip as the service disconnect; and energizing the shunt trip to enter the open state.

14. The method of claim 10, said method further comprising employing a manually operable switch to select between the disconnect mode and an energize mode.

15. The method of claim 14, said method further comprising allowing the power switching device to select the second power source and causing the service disconnect to reconnect the first power source to the power switching device in response to the energize mode.

16. The method of claim 14, said method further comprising requiring the service disconnect to be separately manually operated to enter a closed state to reconnect the first power source to the power switching device.

17. A method of disconnecting power provided to a load through a power switching device of a transfer switch from a first power source capable of providing power to the power switching device and a second power source capable of providing power to the power switching device, said method comprising:
disconnecting the second power source by causing the power switching device to select the first power source in response to a disconnect mode;
disconnecting the first power source by causing a service disconnect interposed between the first power source and the power switching device to enter an open state in response to the disconnect mode; and
allowing, in response to an energize mode, an automatic transfer control to cause selection of the second power source by the switching device in response to failure or instability of the first power source.

18. The method of claim 17, said method further comprising preventing the automatic transfer control from causing the power switching device to select the second power source during the disconnect mode.

19. The method of claim 17, said method further comprising signaling the automatic transfer control to cause the power switching device to select the first power source and to cause the service disconnect to disconnect the first power source from the power switching device in response to the disconnect mode.

20. The method of claim 19, said method further comprising employing a disconnect control to select the disconnect mode.
